(19) United States
(12) Patent Application Publication
(10) Pub. No.: US 2009/0035722 A1
(43) Pub. Date: Feb. 5, 2009

(54) Hydroxyapatite coated nanostructured titanium surfaces

(76) Inventors: Ganesan Balasundaram, Plymouth, MN (US); Tushar M. Shimpi, Plymouth, MN (US); Daniel M. Storey, Minneapolis, MN (US)

Correspondence Address: CHAMELEON SCIENTIFIC CORPORATION;AKA IONIC FUSION CORPORATION, 13355 10TH AVENUE NORTH, SUITE 108, PLYMOUTH, MN, 55441, US

(21) Appl. No.: 11/900,865

(22) Filed: Sep. 13, 2007

Related U.S. Application Data
(60) Provisional application No. 60/953,241, filed on Aug. 1, 2007.

(51) Int. Cl. A61C 8/00

(52) U.S. Cl. 433/201.1

(57) ABSTRACT

Nanotubular structured titanium (Ti) substrates have been coated with nanoparticulate hydroxyapatite (nano-HA). The nano-HA surface is highly adherent to the nanotubular Ti surface and is free of microparticles. The nano-HA coated nanotubular Ti surface promotes osteoblast cell adhesion and is particularly suitable for orthopedic and dental implants where deposition of osteoblasts and other proteins is important in bone formation.

This application claims benefit of U.S. Provisional Patent Application Ser. No. 60/953,241, filed Aug. 1, 2007, which is hereby incorporated by reference herein in its entirety, including any figures, tables, nucleic acid sequences, amino acid sequences, or drawings.

### BACKGROUND OF THE INVENTION

1. Field of the Invention

The invention relates generally to the field of biomaterials and particularly to biocompatible nanostructured hydroxyapatite coatings on nanotubular titanium substrates.

2. Description of Background Art

Titanium and its alloys have been widely used to create dental and orthopedic implants because of their excellent biocompatibility and mechanical properties. Titanium (Ti) spontaneously forms an oxide layer up to a thickness of about 2 to 5 nm both in air and in the body, providing corrosion resistance. However, the normal oxide layer of titanium (TiO₂) is not sufficiently bioactive to form a direct bond with juxtaposed bone, and much effort has been directed to developing coatings on Ti to enhance adhesion to bone as well as to promote adhesion of bone-forming cells. A lack of osseointegration is one factor leading to long-term failure of titanium implants.

In the past, many attempts have been made to improve the surface properties of Ti-based implants; e.g., by modifying Ti topography, chemistry, and surface energy, in order to better integrate into bone. Surface modification techniques have in general been aimed toward increasing surface roughness with the notion that such surfaces provide a more compatible scaffolding for attachment of bone-forming cells. A disadvantage of these approaches is that neither the mechanical nor the chemical methods produce highly controllable surface properties. Moreover, some of these methods have the potential to form surface residuals which can be harmful to osteoblast (bone forming cell) functions.

One method of titanium surface modification at the nanoscale level is use of controlled anodization. Self-assembled layers of vertically oriented TiO₂ nanotubes with defined diameters are readily synthesized (Park, et al, 2007). TiO₂ nanotube arrays can be fabricated by potentiostatic anodization of Ti foil (Paulose, et al., 2006). Lengths up to 134 μm have been achieved using fluoride ion solutions in combination with nonaqueous organic polar electrolytes, including dimethyl sulfoxide, formamide, ethylene glycol and N-methylformamide.

Cell adhesion, spreading and growth on Ti nanotube surfaces is enhanced compared to conventionally available smooth Ti surfaces. Oh, et al. (2006) and others have shown that adhesion/propagation of osteoblasts is substantially improved by the topographical features of the TiO₂ nanotubes.

Several surface modifications and use of different coatings have been investigated as ways to improve osseointegration and biocompatibility. In a study to improve biocompatibility of dental implants, Vrespa, et al. (2002) coated titanium implants with vapor plasma spray applied nitrite titanium. While this process reduced erosion resistance, there was no effect on osseointegration as compared with uncoated Ti. On the other hand, chitosan coated titanium implanted in rabbits indicated some osseointegration similar calcium phosphate coated implants used as controls. The chitosan was solution cast and bonded to rough ground titanium (Bumgardner, et al., 2007). In a study in dogs using Ti coated with type 1 collagen, Welander, et al., (2007) found no significant difference soft tissue healing for non-coated compared to coated Ti implants.

Spire Corporation offers a calcium phosphate thin surface coating on implants such as those used for dental and joint replacement. The product, IONTITE, is advertised as a controlled adherent composition deposited at low temperature onto biomaterials such as stainless steel, titanium, cobalt-chromium and most polymers (Spire Corporation, Bedford, Mass. 01730).

Hydroxyapatite has received considerable attention as a coating on bone implant devices because of its chemical similarity to the mineral component of bone. In cell adhesion studies, Sato, et al. (2005) showed enhanced osteoblast adhesion on hydrothermally treated hydroxyapatite/titania/poly(lactide-co-glycolide) sol-gel titanium coatings. Other workers have suggested that nanophase metals, certain polymers and HA, may stimulate osteoblast interactions, although only nanophase metal surfaces were studied and found to increase osteoblast adhesion (Webster, et al., 2004).

Surface roughness is recognized as an important factor in strengthening adhesion of surface coatings, not only for protective coatings on implant surfaces, but also for more adherent cell attracting interfaces. Hayashi, et al. (2006) reported that hydroxyapatite coated on TiV surfaces of different roughness showed no difference in bone-implant interface shear strength, whereas bead coated porous TiV exhibited significantly greater resistance to shear. The failure site on the tested HA coated implants was at the coating-substrate interface.

Balasundaram, et al. (2006) suggest that osteoblast adhesion is promoted by decreasing particle size and crystallinity on hydroxyapatite surfaces as well as on hydroxyapatite surfaces functionalized with the tripeptide sequence arginine-glycine-aspartic acid (RGD). According to the authors, grain size on hydroxyapatite and other calcium phosphate materials appears to strongly influence osteoblast adhesion.

While some studies on HA coated Ti suggested that HA should be coated on rough surfaces to avoid failure at the substrate interface, HA spray coated on Ti exhibited many failed regions in vivo either at the HA-bone interface or within the bone tissue, despite some improvement in adhesion compared with uncoated Ti (Nakashima, et al., 1997)

### Deficiencies in the Art

Clearly, there is recognition that improvements need to be made in developing coatings on medically important surfaces such as Ti. Of particular importance are coatings which do not slough in the body and which have superior osseointegration properties. Despite progress in modifying metal surfaces to improve tissue and cell adhesion on hydroxyapatite surfaces, adequate adhesion of HA coatings on titanium substrates remains a challenge. Unfortunately, flat and continuous HA or calcium phosphate coatings tend to fail by fracture or delamination at the interface between the implant and the bone.

### SUMMARY OF THE INVENTION

The present invention pertains to nanoparticulate hydroxyapatite (HA) coatings on nanostructured surfaces, and particularly to nanoparticulate HA coated nanotubular titanium surfaces. The HA coating is strongly adhered to the Ti surface. Anchorage-dependent cells, including osteoblasts, exhibit enhanced adhesion to the nanoparticulate HA compared to microparticulate HA surfaces, thus effectively promoting accumulation of calcium-containing minerals required for new bone formation from the extracellular matrix.

The described nanoparticulate HA surface coatings exhibit at least two notable features that distinguish them from HA coatings that have been described as “nano-sized”. Importantly, the disclosed method provides HA coatings that strongly adhere to a nanotubular Ti surface. The HA does not slough in media at a pH near that found in vivo; in contrast, HA coatings deposited on conventional smooth Ti surfaces quickly slough from the substrate surface during in vitro incubation tests and in in vivo tests.

Additionally, as demonstrated in the examples reported herein, the nanoparticulate HA coating is deposited by a molecular plasma deposition process and cured, not sintered, thereby preserving the nanoparticulate features of the HA coating. This provides a surface to which cells such as osteoblasts readily attach. These features promote strong coating adherence and attraction for bone-forming cells.

Once a nanoparticulate HA surface is deposited on the nanotubular Ti surface, a curing step is used which bonds the HA without loss of its nanostructural features. Others have described HA coatings on substrates as “nano-sized” after a sintering step. However, sintering is typically a high heat process and will convert any originally present nanoparticulate HA to micron-sized particles as a result of the bonding and atomic diffusion processes induced by the heat. The curing process used in the process described herein is not a sintering process. The molecular plasma deposited HA is heated well below its melting temperature in the range of only a few hundred degrees, generally no higher than 500° C. and preferably at 200° C. Nanoparticle size is maintained and bonding of the HA to the nanotubular Ti surface is significantly enhanced, resulting in strong adhesion of the coating to the Ti.

The nanotubes on the anodized Ti surface have open ends, which can be filled with deposited nanoparticulate HA. The deposited HA adheres to the inner surface and/or outer surface of the nanotubes to a greater or lesser extent depending on the deposition conditions. Thus the coating is deposited not only on the nanotube surface, but also inside the tubes, thereby filling the tubes, which is believed to contribute to strong adhesion.

Titanium nanotube surface characteristics can be modified by adjusting anodization parameters during the surface treatment of titanium substrates. Nanotube diameter can be controlled by changing the electrolytic solution composition, time of anodization, and temperature at which the anodization is conducted. Larger diameter nanotubes will accommodate larger deposited particulate coatings. Pore diameters ranging from 20 to 500 nm with varying wall thicknesses are readily synthesized, making it possible to load larger particles into the nanotubes. In a preferred embodiment, a pore diameter of about 70 nm results in more deposition of nanoparticulate HA than in the 120 nm pore diameter nanotubes.

Nanotube length (height) can also be controlled so that the titanium nanotube surface is relatively uniform. Uniformity provides a more level surface on which depth of deposited biomolecule layers can be better controlled.

While the invention has been illustrated with a surface-modified (nanotubular) Ti substrate, it is believed that a nanotubular surface can be created on titanium-based substrates; e.g. nickel/titanium, and various titanium compositions with molybdenum, zirconium, niobium, aluminum, iron, vanadium, and tantalum. Several of these alloys are currently used in the fabrication of medical implant devices.

Nanoparticulate HA is deposited by a molecular plasma deposition (MPD) process onto a nanostructured nanotubular titanium surface. The MPD process results in clumps of HA, which are not evenly distributed over the surface. Using a low temperature curing in the range of 200° C., the HA surface becomes relatively even, while still retaining nanoparticulate features and hydroxyapatite crystalline phase. Higher temperatures, e.g, sintering, convert the deposited nanoparticles to micron-sized particles, which have less surface area and changes in the hydroxyapatite crystalline phase. Importantly, the cured nanoparticulate HA is highly adherent to the nanotubular Ti surface so that even after several hours incubation in an aqueous buffer at physiological pH, the HA coating remains intact.

The described nano HA coated nanotubular titanium surfaces promote cell adhesion to a greater extent than to nanotubular titanium surfaces without the HA coating. The greater density and adherence of osteoblast cells to the nanoparticulate HA surfaces provides a significant advantage over currently used coatings in orthopaedic implants.

### DEFINITIONS

Sintering is understood to be the process of heating at a temperature below the melting point of the main constituent for the purpose of increasing strength through bonding together of the particles. Sintering strengthens a powder mass and normally produces densification and, in powdered metals, recrystallization. Atomic diffusion occurs so that welded areas formed during compaction grow until they may be lost completely. Sintering of HA is generally conducted at temperatures near 1000° C., which is close to the melting point.

Curing is the heating of a material, particularly as used herein with respect to hydroxyapatite, to a temperature that does not induce recrystallization and does not change particulate size. The temperature employed to cure hydroxyapatite is in the range of 100-500° C., which is well below the melting and sintering temperatures.

### BRIEF DESCRIPTION OF THE FIGURES

FIG. 1A is a 3-D Atomic Force microscopy image of an unanodized titanium surface.

FIG. 1B is a 3-D Atomic Force microscopy image of an anodized titanium surface.

FIG. 2 is a sketch of the molecular plasma deposition apparatus used to deposit hydroxyapatite coatings.

FIG. 3 is an XRD pattern for nanohydroxyapatite powder; the A and B patterns show the powder heated to 200° C. and 500° C. respectively; the C pattern matches a different crystal form of hydroxyapatite identified as Whitlocktite obtained after heating to 900° C.

FIG. 4A is an SEM image of an unanodized titanium surface. Bar is 600 μm.

FIG. 4B is an SEM image of an anodized titanium surface. Bar is 600 μm.

FIG. 5A is an SEM image of nano-hydroxyapatite coated anodized Ti heated to 200° C.

FIG. 5B is an SEM image of nano-hydroxyapatite coated anodized Ti heated to 500° C.

FIG. 5C is an SEM image of nano-hydroxyapatite coated anodized Ti heated to 900° C.

FIG. 6A is an Atomic Force Microscopic image of nano-hydroxyapatite coated anodized Ti heated to 200° C.

FIG. 6B is an Atomic Force Microscopic image of nano-hydroxyapatite coated anodized Ti heated to 500° C.

FIG. 6C is an Atomic Force Microscopic image of nano-hydroxyapatite coated anodized Ti heated to 900° C.

FIG. 7A shows low magnification SEM image of a nanoparticulate hydroxyapatite coating on anodized titanium after 4 hr incubation in DMEM media.

FIG. 7B shows high magnification SEM image of a nanoparticulate hydroxyapatite coating on anodized titanium after 4 hr incubation in DMEM media.

FIG. 7C shows low magnification SEM image of a nanoparticulate hydroxyapatite coating on anodized titanium after 24 hr incubation in DMEM media.

FIG. 7D shows high magnification SEM image of a nanoparticulate hydroxyapatite coating on anodized titanium after 24 hr incubation in DMEM media.

FIG. 8 is a transmission electron microscopy (TEM) of a nano-hydroxyapatite coating on anodized titanium. The scale bar is 100 nm.

FIG. 9 compares cell density of osteoblast adhesion on unanodized smooth titanium, anodized titanium, anodized titanium coated with nanoparticulate hydroxyapatite and anodized titanium coated with microparticulate hydroxyapatite. Values are SEM; n=3;*p<0.01 compared to unanodized titanium; **p<0.01 compared to anodized titanium.

FIG. 10A shows fluorescent images of osteoblast cell adhesion after 4 hr on unanodized titanium.

FIG. 10B shows fluorescent images of osteoblast cell adhesion after 4 hr on anodized titanium.

FIG. 10C shows fluorescent images of osteoblast cell adhesion after 4 hr on nanoparticulate hydroxyapatite coated anodized titanium.

FIG. 10D shows fluorescent images of osteoblast cell adhesion after 4 hr on microparticulate hydroxyapatite coated anodized titanium.

FIG. 11A is an SEM image of osteoblast adhesion on anodized nanotubular Ti coated with nano-hydroxyapatite; arrows indicate osteoblast filopodia; bars=10 μm.

FIG. 11B is an SEM image of osteoblast adhesion on anodized nanotubular Ti coated with nano-hydroxyapatite; bars=10 μm.

### DETAILED DESCRIPTION OF THE INVENTION

The present invention provides stable nanoparticulate hydroxyapatite coatings on nanostructured titanium surfaces, which are particularly suitable as coatings on implants where bone growth is required. The deposited nanoparticulate HA closely mimics normal bone structure so that osteoblast growth and proliferation on the coating scaffold is enhanced compared to osteoblast adhesion on metal or polymer surfaces.

While titanium and its alloys are widely used in orthopedic and dental applications, the titanium oxide surface that forms when the metal is exposed to air is not sufficiently bioactive to bond with bone. It has been found that increased osteoblast adhesion occurs on nanoparticulate HA deposited on electrochemically anodized titanium surfaces. Unanodized titanium surfaces, in contrast, are poor substrates for coating materials and exhibit little, if any, tendency to attract cells.

By using selected anodization conditions, nanotubes can be created on a titanium metal surface, thereby mimicking features of natural bone. Type I collagen is the main organic component of bone, exhibiting a triple helix 300 nm in length, 0.5 nm in width and a periodicity of 67 nm. All type I collagen dimensions and inorganic bone components are compatible with the dimensional aspects of the nanostructured titanium surface. Hydroxyapatite (HA) and other calcium phosphates have particle sizes approximately 20-40 nm in length. HA crystals are patterned anisotropically within the collagen network in the long bones of the body. It is considered desirable to develop HA coatings on metals used for orthopedic implants because such natural coatings are expected to enhance bone formation.

The nanotube titanium surface produced under the described anodization conditions is more compatible with natural bone than the micropatterned surfaces commonly found on orthopedic implants. Both length and nanotube diameter can be changed to accommodate desired deposited materials, such as the different types of collagen, hydroxyapatite and other calcium phosphate based compounds, whether natural or synthetic, that may be suitable for enhancing osteoblast adhesion and bone growth. Modifications in the diameter and length of the nanotubes formed on Ti surfaces by etching processes can be made so that pore diameter can range from about 30 to over 500 nm (Grimes, 2006). Pore size and other characteristics of an anodized titanium surface are controlled by electrolyte composition, pH and length of time the anodization process is carried out.

Osteoblast cells adhering to the appropriate matrix will promote bone formation by attracting bone forming cells in vivo; i.e., osteoblasts, osteoclasts and osteocytes. As shown herein, nanoHA coated nanotubular Ti surfaces exhibit excellent cell-attracting characteristics. Cell densities of osteoblasts deposited in vitro from DMEM media were higher on nanoparticulate HA coated nanotubular Ti than on microparticulate HA coated Ti, nanotubular Ti or on conventional smooth Ti surfaces.

The following examples are provided as illustrations of the invention and are in no way to be considered limiting.

### EXAMPLES

### Materials and methods

XRD was obtained with a Siemens D500 Kristalloflex (Bruker AXD, Inc.) using Cu-Ka radiation. TEM was obtained with a JEOL 1200 EXII.

SEM measurements were made on substrates sputter-coated with a thin layer of gold using an Ernest Fullam Sputter Coater, Model AMS-76M, in a 100 mTorr vacuum in argon for 3 min at 10 mA. Images were taken using a TESCAN MIRA/LSM SEM at a 20 kV accelerating voltage. Digital images were recorded using the TESCAN-MIRA software.

When fluorescence measurements are desired, substrates can be stained using a CBQCA amine-labeling kit (Molecular Probes, Eugene, Oreg.) following manufacturer instructions and then visualized by fluorescence microscopy. CBQCA is a non-fluorescence molecule but upon reaction with amine groups in the presence of cyanide molecules, exhibits fluorescence. Images can be obtained using software interfaced with fluorescence microscopy. Osteoblasts (CRL-11372) were purchased from American Type Culture Collection; and Endothelial Cells were obtained from VEC Technologies, (Rensselaer, N.Y.).

### Preparation of Anodized Ti

Ti foils with a thickness of 250 μm (99.7%; Alfa Aesar) were ultrasonically cleaned with water, 2-propanol, and water for 30 minutes. The cleaned substrates were then etched with 5M nitric acid for 3 minutes and cleaned ultrasonically 3 times with deionized water for 10 minutes. The foils were subjected to potentiostatic anodization in a two-electrode electrochemical cell connected to a DC power supply. In all cases, a platinum foil (Alfa Aesar) was used as the counter electrode. All of the experiments were performed at or near room temperature. A 20 V anodizing voltage was applied for 10 minutes. Substrates were then rinsed with deionized water followed by 3 washes with 2-propanol and stored at 60° C. for 8 hours. Anodized samples were kept under desiccation until further use.

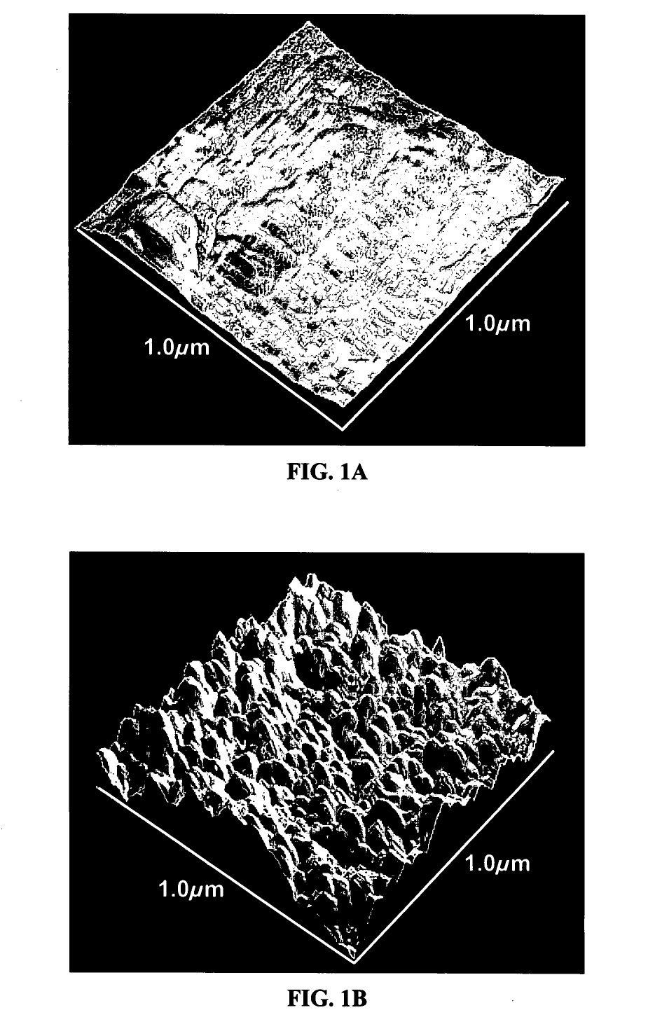

FIG. 1 is a 3-D atomic force microscopic (AFM) image of unanodized Ti (FIG. 1A) compared to anodized Ti (FIG. 1B).

### Molecular Plasma Deposition (MPD) Method

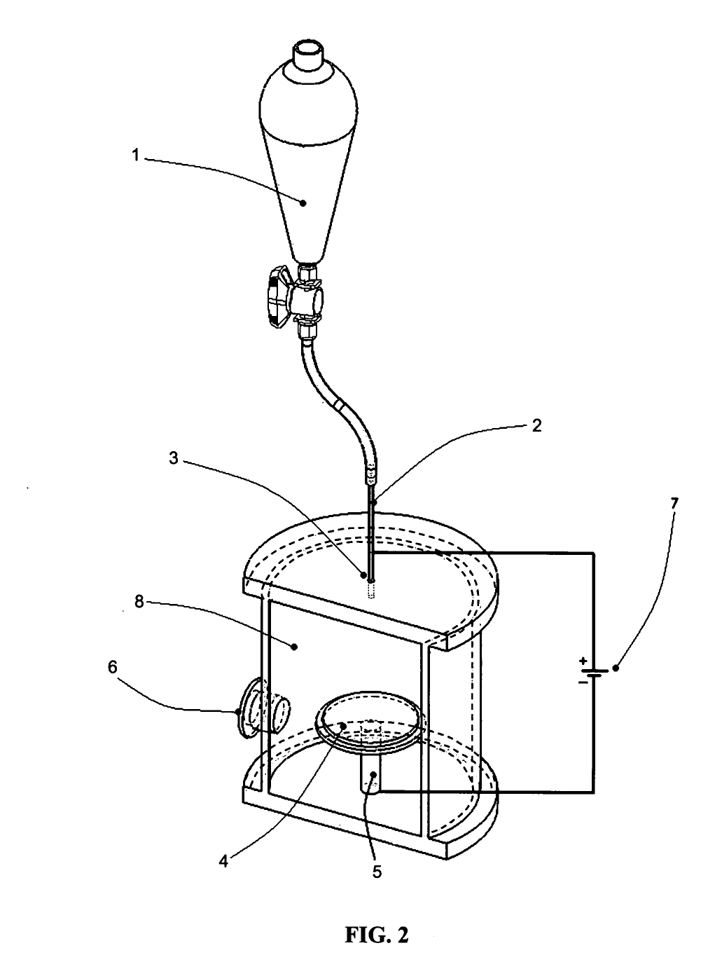

The deposition apparatus shown in FIG. 2 for plasma deposition onto a substrate surface (4) with an optionally movable substrate holder (5) includes a vacuum chamber (8) with a small aperture (3), and a small bore, metallic needle (2) connected to a tube connected to a reservoir holding a liquid suspension or solution of the material (1) desired to be deposited. The reservoir is at atmospheric pressure. A power supply (7) with the ability to supply up to 60 kV can be employed; however, the voltage attached to the needle is typically −5000 volts to +5000 volts. The substrate inside the vacuum chamber is centered on the aperture (3) with a bias from −60 kV through −60 kV, including ground.

The apparatus and modifications that allow generation of a molecular plasma are such that the needle, tube, and reservoir can be disposed in a separate enclosure (not shown) that excludes air, but allows introduction of other gases or use of a partial vacuum somewhat below atmospheric pressure. Optionally selected gases include argon, oxygen, nitrogen, xenon, hydrogen, krypton, radon, chlorine, helium, ammonia, fluorine and combinations of these gases. While atmospheric pressure is generally preferred for generation of the plasma at the needle tip, reduced pressure in the separate chamber housing the needle, tube and reservoir can be up to about 100 mTorr may in some instances provide satisfactory depositions.

For use as illustrated in FIG. 2, the pressure differential between the corona discharge at the needle tip (2) and the substrate in the evacuated chamber (8) is about one atmosphere. The outside pressure of the vacuum chamber is typically approximately 760 Torr, whereas pressure in the area of the substrate is approximately 0.1 Torr.

To prepare nano-HA coated anodized Ti substrates, 10 ml of a colloidal solution of nanoparticulate HA was loaded into the reservoir (see FIG. 1) and deposition under vacuum at 200 mTorr onto the anodized Ti substrate was conducted for about 5 min using an applied voltage of 20-25 kV.

### Example 1

### Preparation of Hydroxyapatite

### Nanoparticulate HA

Hydroxyapatite is formed in accordance with the reaction:

10Ca(NO₃)₂+6(NH₄)₂HPO₄+8NH₄OH→Ca₁₀(PO₄)₆(OH)₂+6H₂O+20NH₄NO₃

Nanoparticulate HA was synthesized suing a wet chemical process followed by hydrothermal treatment. Concentrated ammonium hydroxide was used to maintain the reaction mixture at pH 10 throughout the reaction. 0.6M ammonium phosphate and 1.0M calcium nitrate were also added slowly at 3.6 ml/min. Calcium phosphate precipitation occurred while stirring for 10 min at room temperature. After 10 min, suspension volume was reduced by 75% using centrifugation. The concentrated HA precipitated aqueous solution was added to a 125 ml TEFLON liner (Parr Instruments). The liner was sealed tightly in an autoclave (Parr Acid Digestion Bomb 4748) and processed hydrothermally at 120° C. for 20 hr. After hydrothermal treatment, the HA particles were rinsed 3 times with deionized water.

Nanoparticulate hydroxyapatite was characterized by X-ray diffraction (XRD), inductively coupled plasma atomic emission spectroscopy (ICP-AES) to measure Ca/P ratio, a particle size analyzer to measure the agglomerated mean particle size, BET to measure individual particle size, and Scanning Electron Microscope (SEM) to characterize particle morphology.

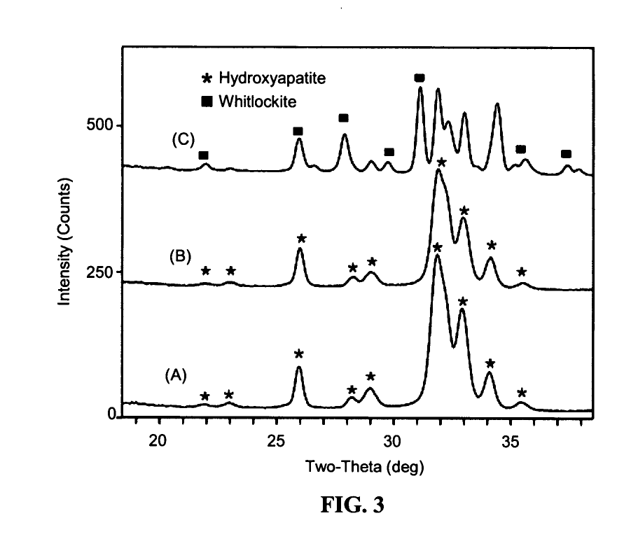

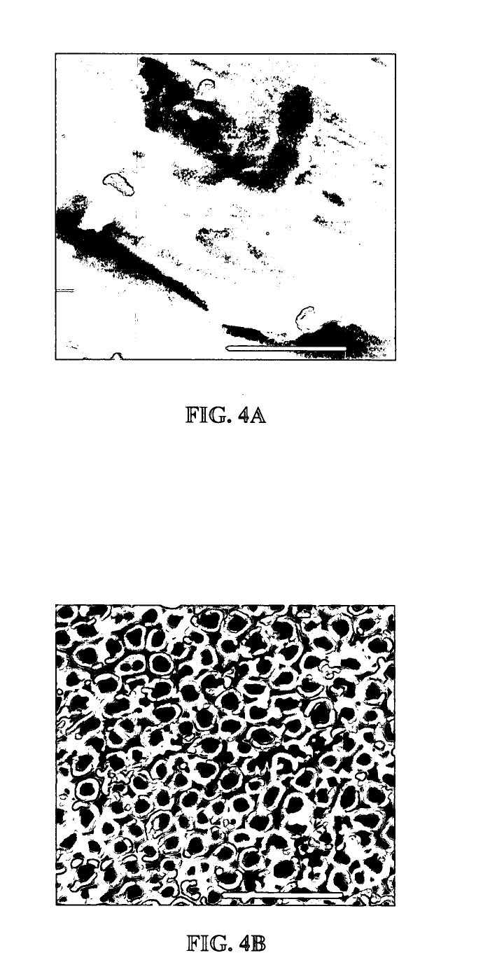

X-ray diffraction (XRD) showed that nanoHA powders retain nanostructural features (HA crystalline phase) after heating at 200° C. (FIG. 3A) and at least up to 500° C. (FIG. 3B). However, when heated to 900° C., HA converted to different crystal forms, mainly whitlockite, which is a different HA crystalline phase (FIG. 3C).

### Microparticulate Hydroxyapatite

Micron-sized hydroxyapatite was obtained as described above except that the concentrated HA was hydrothermally digested at 200° C. in a Parr Digestion Bomb, and the precipitated paste washed with water to strip of side products and contaminants before drying in a glass Petri dish in an oven at 70° C. for 24 hr. The pellets so produced were crushed using mortar and pestle to obtain a fine powder. Micron-sized HA was obtained by drying the powder, then sintering at 1100° C. in air for 2 hr with a kiln ramp rate of 22° C./min.

### Characterization of Surfaces and Surface Coatings

In order to examine the surface characteristics of anodized Ti and HA deposited coatings on anodized Ti substrates, one or more of fluorescence, SEM, TEM and X-ray photoelectron spectroscopy (XPS) methods were used.

SEM spectra were recorded for unanodized Ti and anodized Ti surfaces. While actual measurements were not made, the diameter of the nanotubes on the anodized titanium used in the methods described was approximated at 70 nm and length at about 200 nm, based on measurements made in the past by others who have reported such measurements on anodized surfaces.

Surface roughness of anodized titanium was about 25 nm, compared with unanodized titanium, which has a roughness on the order of 5 nm. Roughness was determined by Ra values measured by SEM analysis of gold sputtered anodized substrates. A selected kV was used to obtain images of substrate topography at low and high magnification in order to observe pore geometry and surface feature size.

Surface roughness was quantified using an atomic force microscope (AFM) interfaced with imaging software. A scan rate, typically 2 Hz, was used at a selected scanning point; e.g., 512, to obtain root mean square roughness values. Scans were performed in ambient air at 15-20% humidity. 1×1 μM AFM scans were employed for plain substrates and 2×2 μM for coated substrates. Anodized Ti (FIG. 3A) showed a rough surface morphology compared to unanodized Ti (FIG. 3B).

### Example 2

### Anodization of Titanium Substrates

Ti samples (10×10×1 mm), 99.7% pure (Alfa Aesar), 250 um thick, were cleaned ultrasonically with ethanol and water before being etched in a mixture of HF/HNO₃. The pretreated samples were anodized in 1.5% hydrofluoric acid. A DC power supply with a current density of 7 A/m² was used. A 10V anodizing voltage was applied for 10 min. Samples were rinsed with deionized water and dried with nitrogen immediately after anodization. Prior to exposure to cell cultures, the titanium samples were ultrasonically cleaned and sterilized in 70% ethanol for 15 min, rinsed in deionized water and air dried under a laminar flow hood.

Alternatively, etching time may be carried out for minutes to hours and/or the electrolyte can be hydrofluoric acid (HF) or mixtures of HF with dimethylsulfoxide (DMSO) in various ratios. Such modifications, which are known in the art, result in nanotube structures having different tube diameters and heights.

The anodized titanium substrate surfaces were characterized by scanning electron microscopy (SEM). Prior to scanning, substrates were sputter-coated with a thin layer of gold-palladium using a Hummer I Sputter Coater (Technics) in a 100 mTorr vacuum argon environment for 3 min at 10 mA current. Images were taken using a JEOL JSM-840 Scanning Electron Microscope at 5 kV accelerating voltage. Digital images were recorded using a Digital Scan Generator Plus (JEOL) software. Substrate surfaces were characterized by scanning electron microscopy (SEM). For SEM, substrates were first sputter-coated with a thin layer of gold using an Ernest Fullam Sputter Coater (Model; AMS-76M) in a 100 mTorr vacuum argon environment for a 3 min period and 10 mA of current. Images were taken using a TESCAN-MIRA/LSM SEM at a 20 kV accelerating voltage. Digital images were recorded using the TESCAN-MIRA software.

### Example 3

### HA Coated Ti Substrates

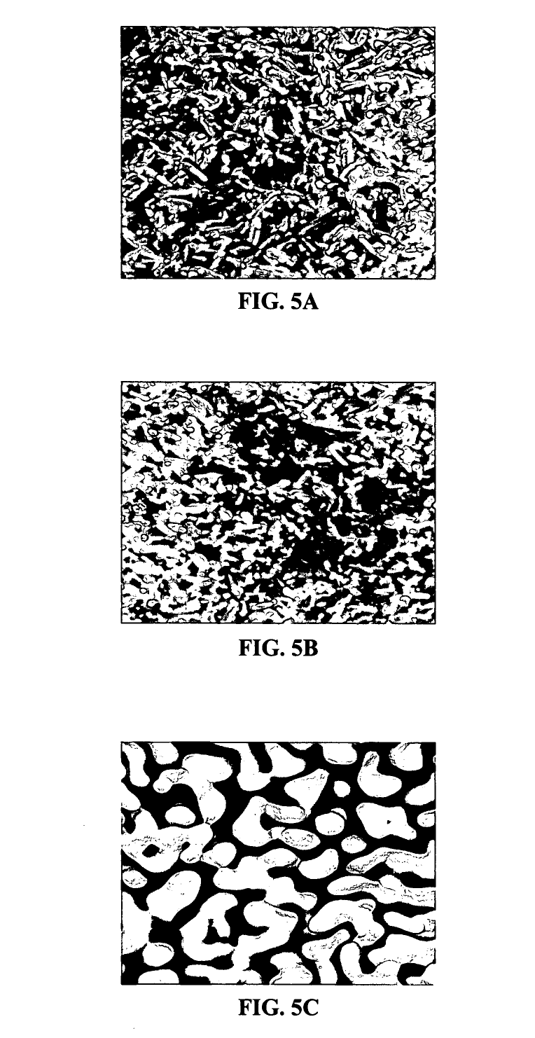

XRD on nano-HA coated nanotubular Ti indicated that the HA single phase was maintained after deposition and heating of the coated substrates up to 500° C. SEM images of the nanoHA coating at 200° C. (FIG. 5A) and 500° C. (FIG. 5B) confirmed the HA nanostructure.

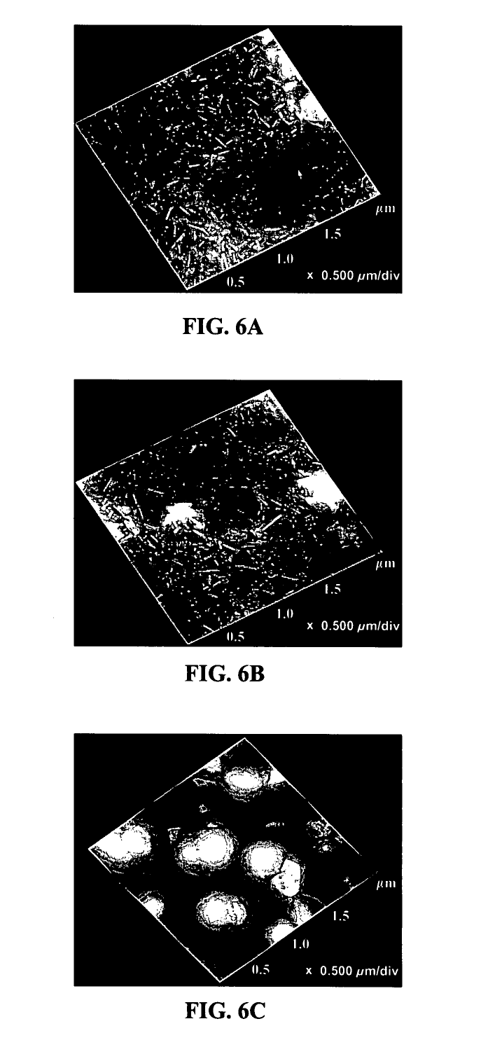

However, after curing at 900° C., the nanostructure features were lost (FIG. 5C). AFM images of nanoHA coated Ti heated at 200° C. (FIG. 6A), at 500° C. (FIG. 6B) and at 900° C. (FIG. 6C) show that the HA nanostructure is altered after curing at 900° C. and loses nanostructure features. Agglomeration begins to occur at 500° C. and particle shapes have changed from nano to broadly distributed micron size particles.

Stability of the nanoHA coating on nanotubular Ti surfaces was tested by soaking in DMEM media at 37° C. for 4 hr and 24 hr. The substrates were rinsed 1× with phosphate buffer followed by 3× with deionized water and 3× with anhydrous ethanol. Coated substrates were dried under vacuum for 4 hr.

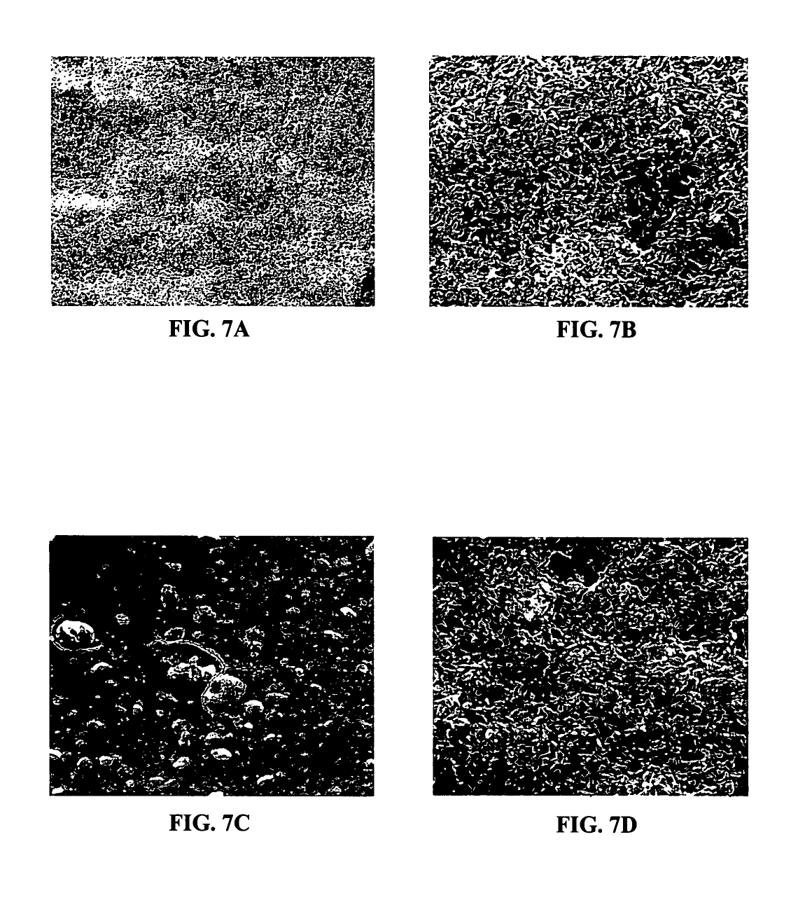

Tests showed that the HA coatings were stable for up to at least 24 hr, thereafter slowly disengaging from the surface. SEM images shown in FIG. 7A show that a nanoparticulate HA coating on anodized Ti is stable after 4 hr incubation in DMEM and retains its nanostructure. The particle shapes are uniform throughout the surface and no surface cracks were visible. Even after 24 hr in DMEM, the nanostructured surface remains intact (FIG. 7B) although there is some evidence of cracking observed in the low magnification image (FIG. 7B).

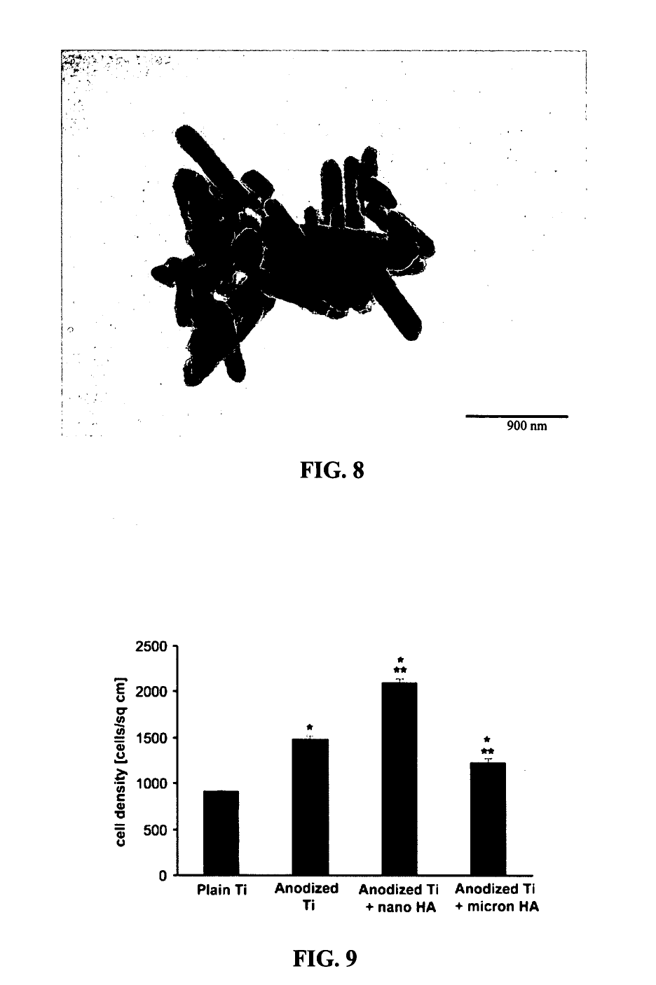

Transmission electron microscopy (TEM) data confirmed the nanoparticulate nature of the deposited HA coating on Ti substrates. Nanocrystalline HA particles processed hydrothermally were rod-like in appearance, exhibiting a length of 50-100 nm and diameters of 15-20 nm (FIG. 8).

### Example 4

### Osteoblast Cell Adhesion

Nano-sized hydroxyapatite prepared as described was deposited on an anodized (nanotubular) titanium substrate using the molecular plasma discharge procedure described. The nano-HA was prepared as a colloidal suspension in water and ejected from a high voltage tip to form a corona discharge. The ionized material was directed through an aperture into an evacuated chamber onto a nanotubular titanium substrate that was either grounded or oppositely biased (FIG. 2).

Anodized titanium substrates were sterilized under UV light for 4 hours prior to cell incubation. Human osteoblasts (bone-forming cells; CRL-11372 American Type Culture Collection, population numbers 5-7) in Dulbecco's Modified Eagle Medium (Gibco) supplemented with 10% fetal bovine serum (Hyclone) and 1% Penicillin/Streptomycin (Hyclone) were seeded at a density of 3500 cells/cm² onto the substrate and were then incubated under standard cell culture conditions (humidified, 5% CO₂/95% air environment, 34° C.). After 4 hr incubation, the substrates were rinsed in phosphate buffered saline to remove any non-adherent cells. The remaining cells were fixed with formaldehyde (Aldrich Chemical Inc, USA), stained with Hoescht 33258 dye (Sigma), and counted under a fluorescence microscope (Leica, DM IRB). Five random fields were counted per substrate sample. Standard t-tests were used to check statistical significance between cell adhesion numbers.

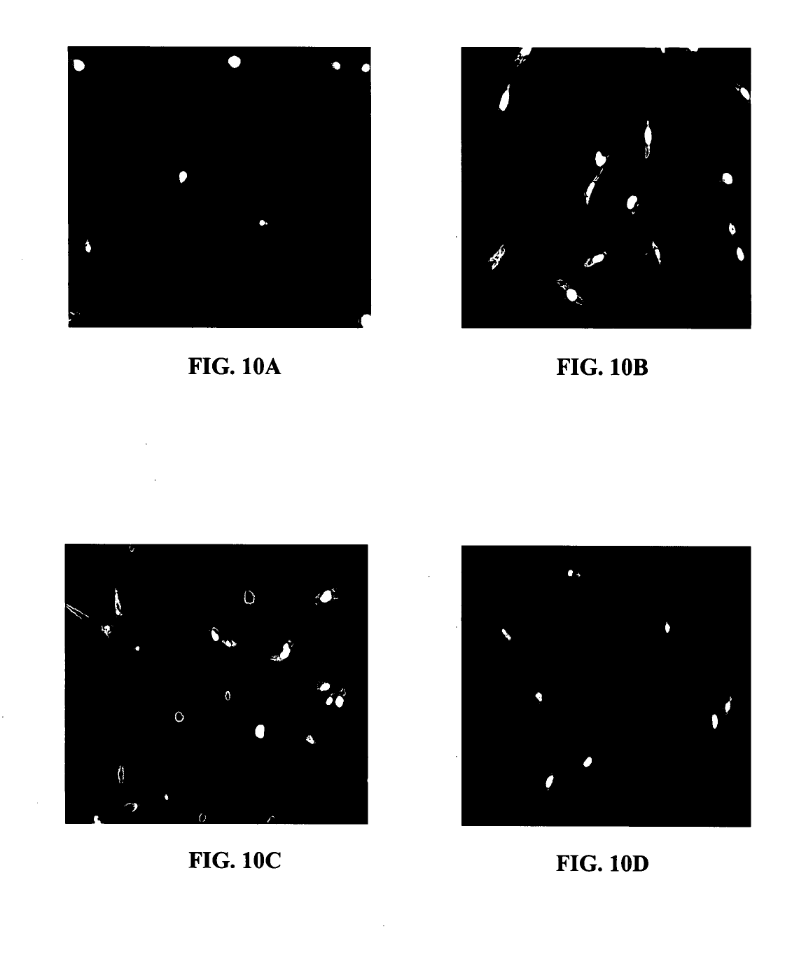

FIG. 9 shows results of osteoblast adhesion after 4 hr incubation. Anodized Ti showed an increased osteoblast number compared to an unanodized substrate. Nano-HA coated anodized Ti showed greatest osteoblast adhesion compared to unanodized, anodized and micron-HA coated anodized Ti. The increased osteoblast adhesion on anodized Ti and anodized Ti coated with nano-HA was also demonstrated from fluorescent images visualized with a Hoechst stain as shown in FIGS. 10A-D. Significantly less adhesion is seen on micron-HA coated anodized Ti than on nano-HA coated anodized Ti or smooth Ti surfaces.

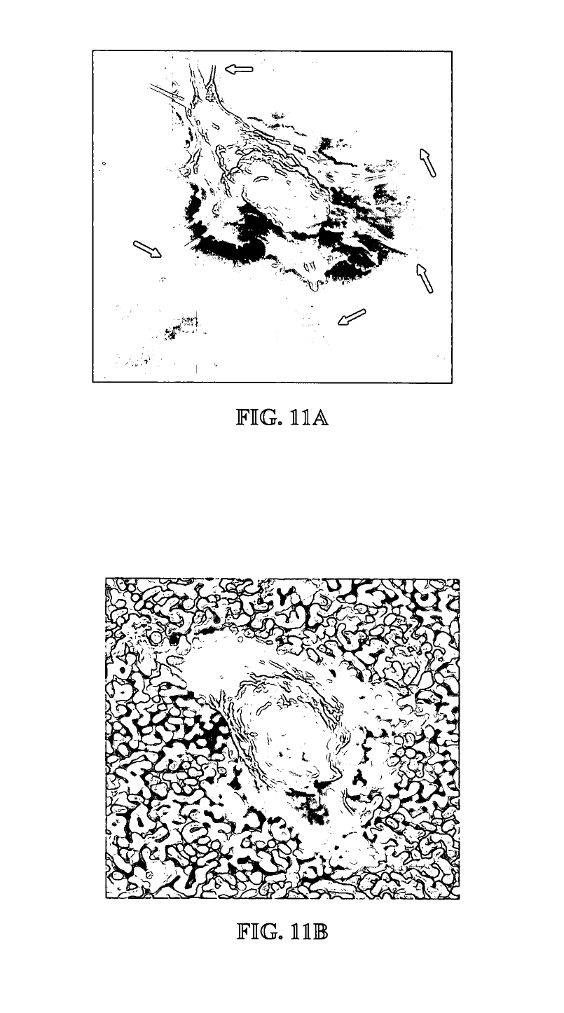

Osteoblast adhesion on anodized Ti and anodized Ti coated with nano-HA showed a wide-spread morphology compared to a smooth uncoated Ti substrate and micron-HA coated substrates. The SEM images of the cells adhering to nano-HA coated Ti showed that the cells had a wide-spread morphology with extended filapodia (FIG. 11A). However, such features were not observed with micron-HA coated surfaces (FIG. 11B). Overall, SEM images showed that the morphology and spreading of osteoblast cells 4 h after attachment are strongly dependent on the characteristics of the underlying HA coating surface.

### REFERENCES

Balasundaram, G., Sato, M., and Webster, T. J., “Using hydroxyapatite nanoparticles and decreased crystallinity to promote osteoblast adhesion similar to functionalizing with RGD”, Biomaterials 27, 2798-2805 (2006)
Webster, T. J., and Ejiofor, J. U., “Increased osteoblast adhesion on nanophase metals: Ti, Ti6A14V, and CoCrMo” Biomaterials 25, 4731-9 (2004)
Rezania, A., and Healy, K. E. “Integrin subunits responsible for adhesion of human osteoblast-like cells to biomimetic peptide surfaces”, J. Orthop. Res, 17: 615-623 (1999).
Ferris, D. M., Moodie, G. D., Dimond, P. M., Gioranni, C. W., Ehrlich, M. G., Valentini, R. F., “RGD-coated titanium implants stimulate increased bone formation in vivo”, Biomaterials 20:2323-2331 (1999).
Grimes, C. A., J. Phys. Chem. Letters B, 110, 16179-16184 (2006)
Villard, et al., J. Peptide Science, 12, 206-212 (2006)
Kasai, et al., Biopolymers, 76, 27-33 (2004)
Paulose, et al., J. Phys. Chem. B, 110(33), 16179-16184 (2006)
US Pub. No. US2007/0031388 (Geistlich)
U.S. Pat. No. 6,291,428
Bessho, K., Kusumoto, K., Fujimura, K., Konishi, Y., Ogawa, Y., Tani, Y., Iizuka, T. (1999). Comparison of recombinant and purified human bone morphogenetic protein. Br. J. Oral Maxillofac. Surg. 37, 2-5.
Boden, S. D. (1999). Bioactive factors for bone tissue engineering. Clin. Orthop. Relat. Res. 367, 84-94.
Burt, D. W., Law, A. S. (1994). Evolution of the transforming growth factor-beta superfamily. Prog. Growth Factor Res. 5, 99-118.
Chen, P., Carrington, J. L., Hammonds, R. G., Reddi, A. H. (1991). Stimulation of chondrogenesis in limb bud mesoderm cells by recombinant human bone morphogenetic protein 2B (BMP-2B) and modulation by transforming growth factor beta 1 and beta 2. Exp. Cell Res. 195, 509-515.
Poynton, A. R., Lane, J. M. (2002). Safety profile for the clinical use of bone morphogenetic proteins in the spine. Spine. 27, 40-48.
Urist, M. R. (1965). Bone: formation by autoinduction. Science. 150, 893-899.
Wozney, J. M., Rosen, V., Byrne, M., Celeste, A. J., Moutsatsos, I., Wang, E. A. (1990). Growth factors influencing bone development. J. Cell Sci. 13, 149-156.
Welander, M. Abrahamsson, I., Linder, E., Liljenberg, B., Berglundh, T., “Soft tissue healing at titanium implants coated with type I collagen. An experimental study in dogs”, J. Clin. Periodontology, v. 34(5), 452-458 (2007) published online 13 Mar. 2007.
Bumgardner, J. D., Chesnutt, B. M., Yuan, Y., Yang, Y., Appleford, M., Oh, S., McLaughlin, R., Elder, S. H., and Ong, J. L., “The integration of chitosan-coated titanium in bone: an in vivo study in rabbits”, Implant Dentistry, 16(1): 66-79 (2007)
Nakashima, Y., Hayashi, K., Inadome, T., Uenoyama, K., Hara, T., Kanemaru, T., Sugioka, Y., and Noda, I. “Hydroxyapatite-coating on titanium arc sprayed titanium implants”, J. Biomed. Mater. Res., 35(3), 287-298 (1997)
Park, J., Bauer, S., von der Mark, K. and Schmuk, P., “Nanosize and vitality: TiO2 nanotube diameter directs cell fate”, Nano Letters, published on Web May 16, 2007.
Oh, S., Daraio, C., Chen, Li-Han, Pisanic, T. R., Finones, R. R. and Jin, S., “Significantly accelerated osteoblast cell growth on aligned TiO₂ nanotubes”, Wiley Periodicals, Incl, published online 6 Apr. 2006 (www.interscience.wiley.com).

What is claimed is:

1. A nanostructured titanium (Ti) surface coated with nanoparticulate hydroxyapatite (HA).

2. The Ti surface of claim 1 wherein the nanostructured surface comprises nanotubes.

3. The Ti surface of claim 2 wherein the nanotubes are about 20-120 nm in diameter.

4. The Ti surface of claim 2 wherein the nanotubes are about 70 nm in diameter.

5. A method for preparing an adherent hydroxyapatite (HA) coating on a titanium (Ti) substrate, comprising:
depositing a suspension of nanoparticulate HA onto an anodized titanium surface from a molecular plasma to form a nanoHA-coated Ti substrate; and
curing the coated substrate at a temperature below sintering temperature of HA;
wherein the nanoparticulate HA coating exhibits increased adherence to the substrate compared to an uncured nanoparticulate HA coating.

6. The method of claim 5 wherein the curing is up to about 500° C.

7. The method of claim 5 wherein the curing is up to about 200° C.

8. The method of claim 5 wherein the curing is conducted for about 4 to about 24 hours.

9. The method of claim 5 wherein the cured coated substrate surface is substantially free of microparticulate HA.

10. The method of claim 5 wherein the anodized titanium substrate comprises a nanotubular surface.

11. A nanotubular titanium implant coated with nanoparticulate hydroxyapatite effective as a scaffold for cell deposition.

12. The nanotubular implant of claim 11 wherein the cell is an osteoblast, fibroblast, epithelial cell or combinations thereof.

13. The implant of claim 12 wherein the cell is an osteoblast cell.

14. The implant of claim 12 wherein the cells adhere to the implant in vitro in physiologically compatible media.

15. The implant of claim 11 which is a bone implant.

16. The implant of claim 15 which is a dental bone implant.
